(19) United States
(12) Patent Application Publication
(10) Pub. No.: US 2008/0121012 A1
(43) Pub. Date: May 29, 2008

(54) Electrode Calibration

(76) Inventor: Roberto Angelo Motterlini, Middlesex (GB)

Correspondence Address: NIXON & VANDERHYE, PC, 901 NORTH GLEBE ROAD, 11TH FLOOR, ARLINGTON, VA, 22203, US

(21) Appl. No.: 11/596,977

(22) PCT Filed: May 20, 2005
(86) PCT No.: PCT/GB05/02012

§ 371 Date: Dec. 14, 2006

(30) Foreign Application Priority Data
May 20, 2004 (GB) 0411261.1

(51) Int. Cl. G12B 13/00

(52) U.S. Cl. 73/1.03

(57) ABSTRACT

A method and kit for calibrating a CO-concentration sensing electrode that employs a standard solution obtained by dissolving a predetermined amount of a CO-releasing boranocarbonate to provide a known concentration of CO.

### FIELD OF THE INVENTION

This invention relates to a method of calibrating a CO-concentration sensing electrode, and to such an electrode calibrated by the method.

### BACKGROUND OF THE INVENTION

The appreciation of carbon monoxide (CO) as a ubiquitous biological mediator has always been permeated by controversy and skepticism. For many it is, and perhaps will always remain, a rather intriguing possibility (ref. 1).

Research on CO in the biomedical field has always been directed towards, and somehow restricted to, its interaction with heme moieties. By comparison with the now well-studied molecule NO (nitric oxide) there has been a lack of information on the chemical reactivity of CO gas in aqueous solutions with non-heme metal centers or other potential targets present in mammalian proteins and enzymes.

Furthermore, a suitable tool for the detection and quantification of CO has not been available at least until recently.

It has been recently discovered that certain transition metal carbonyls have the inherent ability to liberate CO under appropriate conditions and function as CO-releasing molecules (CO-RMs) in biological systems (refs. 2-4). The first two carbonyl complexes initially identified and possessing such prerequisites were manganese decacarbonyl ([Mn₂(CO)₁₀]) and tricarbonyldichlororuthenium(II) dimer ([Ru(CO)₃Cl₂]₂), which have been subsequently termed CORM-1 and CORM-2, respectively (ref. 4). Although these two compounds are soluble only in organic solvents and CORM-1 requires light to induce CO loss, they both proved to be pharmacologically active by exerting effects that are typical of CO including vessel relaxation, attenuation of coronary vasoconstriction and suppression of acute hypertension (ref. 3). Lately, further progresses have been made by synthesizing the first prototype of a water-soluble CO-RM; this was attained primarily to overcome the solubility constraints and the fact that the majority of carbonyl-based compounds described in the literature requires physical (e.g. irradiating light) or chemical (e.g. ligand substitution) stimuli to promote CO dissociation (ref. 3).

Tricarbonylchloro(glycinato)ruthenium(II) (CORM-3), which can be obtained by coordinating the aminoacid glycine onto the metal center, is fully soluble in water and rapidly liberates CO in vitro, ex-vivo and in vivo biological models (ref. 4). It has been shown that CORM-3 protects myocardial tissues against ischemia-reperfusion injury both ex-vivo (ref. 5) and in vivo (ref. 6) and prolongs the survival of cardiac allografts in mice (ref. 5). More recently, evidence has been provided showing important vasodilatory properties of CORM-3 through mechanisms that involve guanylate cyclase and potassium channel activation (ref. 7). Recently sodium boranocarbonate (Na₂[H₃BCO₂], here termed CORM-A1) has been identified as an extremely promising water-soluble compound that spontaneously liberates CO in aqueous solutions (WO 2005/013691 and ref. 9).

### SUMMARY OF THE INVENTION

Based on the experimental results given below, we have found that accurate reproducible calibration of CO-concentration detecting electrodes is possible by use of soluble boranocarbonate compounds. This opens the way to precise analysis of concentration of CO in solution, e.g. aqueous solution. Hitherto convenient and/or accurate methods of determining CO in solution have not been available.

According to the invention, there is provided a method of calibrating a CO-concentration sensing electrode, wherein at least one solution containing a known concentration of CO obtained by dissolving a predetermined amount of a CO-releasing boranocarbonate compound is employed as a standard solution contacted with the electrode to obtain an output from the electrode enabling its calibration.

Preferably a plurality of standard solutions of different CO-concentration are contacted with the electrode to obtain a plurality of outputs enabling its calibration.

Boranocarbonates are a group of compounds which can loosely be described as carboxylate adducts of borane and derivatives of borane. Boranocarbonates generally contain a group of the form —COO⁻ or COOR (where R is H or another group) attached to the boron atom, so that they may be called boranocarboxylates or carboxyboranes, but the term boranocarbonate seems to be preferred. The compound K₂(H₃BCOO) and the related K(H₃BCOOH) are described in reference 8, where K₂(H₃BCOO) is used for producing Tc carbonyls.

Thus typically a boranocarbonate has the molecular structure including the moiety

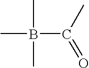

Preferably the boranocarbonate compound has an anion of the formula:

BHₓ (COQ)_{y}Z_{z}

wherein:

x is 1, 2 or 3

y is 1, 2 or 3

z is 0, 1 or 2

x+y+z=4,

each Q is O⁺, representing a carboxylate anionic form, or is OH, OR, NH₂, NHR, NR₂, SR or halogen, where the or each R is alkyl (preferably of 1 to 4 carbon atoms),

each Z is halogen, NH₂, NHR′, NR′₂, SR′ or OR′ where the or each R′ is alkyl (preferably of 1 to 4 carbon atoms).

Since this formula is analogous to the borano anion BH₄⁻, the structure generally is an anion. It may be a divalent anion when one (COQ) is present as (COO⁻). If the structure is an anion, a cation is required. Any physiologically suitable cation may be employed, particularly a metal cation such as an alkali metal ion e.g. K⁺ or Na⁺ or an alkaline earth metal cation such as Ca⁺⁺ or Mg⁺⁺. Alternatively non-metal cations might be employed, such as NR₄⁺ where each R is H or alkyl (preferably of 1 to 4 carbon atoms) or PR₄⁺ where R is alkyl (preferably of 1 to 4 carbon atoms). The cation may be selected in order to achieve a desired solubility of the compound.

Preferably y is 1. Preferably x is 3 and y is 1, since the presence of three H atoms attached to B seems to promote CO release. Preferably Q is O⁻, OH or OR.

The boranocarbonate is soluble and may be present in the solution contacting the electrode in a suitable solvent, which typically contains or is a protic solvent, since protons promote the CO release. Preferably the solvent is aqueous (containing at least some water). Water may be used, or the aqueous solvent may be in suitable cases a biological fluid or buffer, such as plasma or blood.

Alternatively the solutions can be provided for contact with the electrode containing dissolved CO, already released by the boranocarbonate. Release of CO, before or during contact with the electrode, may be triggered by change of condition (e.g. pH or temperature).

Preferred boranocarbonates are K₂(H₃BCOO), Na₂ (H₃BCOO), K (H₃BCOOH) and Na (H₃BCOOH).

The invention is therefore based on use of a solution containing, in a reproducible manner, a predetermined amount of dissolved CO, derived from a boranocarbonate (or mixture of boranocarbonates). The solution generally has a predetermined pH and temperature, to ensure the desired CO concentration, particularly if the release of CO is pH-dependent and/or temperature dependent.

In a second aspect, the invention provides a CO-concentration detecting electrode calibrated by the method described above. Typically the electrode is in combination with a data set relating its output to CO-concentration of a liquid medium contacting it. The data set is derived from the calibration procedure and may be a data table or graph, and may be stored in visible form, e.g. on paper, or in electronic or other computer-readable form, e.g. as a data set in a computer-readable memory.

In a further aspect the invention provides a kit for use in calibration of a CO-concentration electrode comprising:

(a) at least one sample of a CO-releasing boranocarbonate compound in a predetermined amount in a sealed first container,

(b) at least one aqueous solution in a predetermined amount in a second container. The kit may also include a CO-concentration electrode.

The kit may have a plurality of said samples (a) and a plurality of said solutions (b). The or each solution (b) may be a buffer solution of predetermined pH. Preferably there are a plurality of said solutions (b) having respectively different pH values; an example is three solutions of pH 3, 6 and 7.4 respectively.

Suitably the kit has means for maintaining at least said sample (a) at a predetermined temperature. A suitable temperature is in the range 0-10° C., e.g. 4° C. Preferably the boranocarbonate is stored in an inert gas atmosphere, e.g. argon or nitrogen.

The invention is applicable to CO-concentration electrodes for detecting CO in solution, such as an electrochemical electrode. An example of a suitable electrochemical sensor for detecting CO in solution is described in U.S. Pat. No. 4,729,824. Another known form of CO electrode is described below.

### INTRODUCTION OF THE DRAWINGS

Experimental data illustrating the present invention will now be described by reference to the accompanying figures, which:

FIG. 1 shows carbonmonoxy myoglobin (MbCO) and deoxy-myoglobin absorption spectra.

FIG. 2 shows a carbonmonoxy myoglobin (MbCO) and deoxy-myoglobin absorption spectra, a graph showing the concentration of MbCO over time, and a graph with a correlation curve.

FIG. 3 shows current-time curves using an amperometric electrode sensitive to CO with the compounds CORM-A1 and iCORM-A1, and a graph with a correlation curve.

### EMBODIMENTS OF THE INVENTION AND EXPERIMENTAL DATA

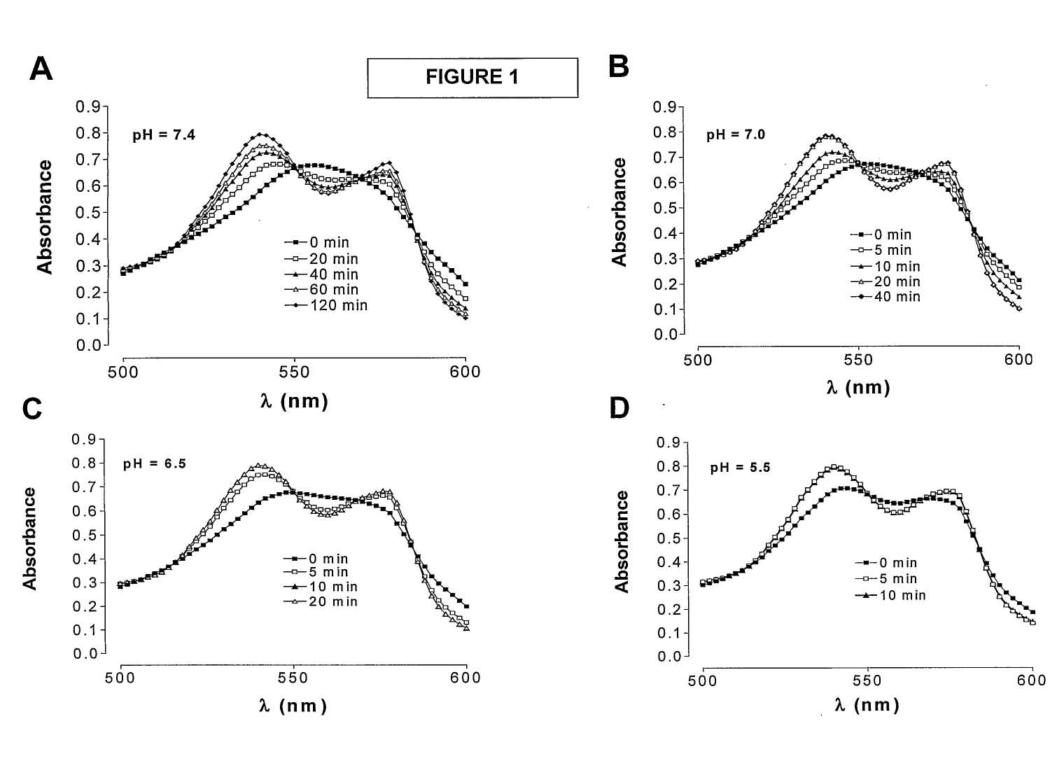

The following experimental data, given with reference to the graphs of accompanying FIGS. 1, 2 and 3, illustrates that boranocarbonate provides accurately reproducible CO solutions suitable for use in electrode calibration. A protocol for calibration is described.

Preparation of Chemicals and Solutions CORM-A1 was prepared as previously described (ref. 7). Stock solutions of CORM-A1 (10-100 mM) were freshly prepared before the experiments by dissolving the compounds in pure distilled water. In our preliminary tests, we noticed that acidic pHs significantly accelerate the spontaneous release of CO from CORM-A1. We therefore took advantage of this specific property of CORM-A1 and generated an inactive form (iCORM-A1) to be used as a negative control by initially dissolving CORM-A1 in 0.1 M HCl and then bubbling pure N₂ through the solution for 10 min in order to remove the residual CO gas from the solution. iCORM was finally adjusted to pH=7.4 and tested with the myoglobin assay prior to each experiment to verify its inability to liberate CO.

### Detection of CO Release using the Myoglobin Assay

The release of CO from CORM-A1 (Na₂[H₃BCOO]) was assessed spectrophotometrically by measuring the conversion of deoxymyoglobin (deoxy-Mb) to carbonmonoxy myoglobin (MbCO) in a manner previously reported (refs. 3, 4, 5). A small aliquot of CORM-A1 (60 μM final concentration) was added to 1 ml deoxy-Mb (≈53 μM) in phosphate buffer and changes in the Mb spectra were recorded over time. The amount of MbCO formed was quantified by measuring the absorbance at 540 nm (extinction coefficient=15.4 M⁻¹ cm⁻¹). In order to examine the effect of pH on the rate of CO liberation from CORM-A1, experiments were conducted using solutions of myoglobin in 0.04 M phosphate buffer prepared at different pHs (7.4, 7.0, 6.5 and 5.5). The amount of MbCO formed was plotted over time and the half-life of CORM-A1 at different pHs and temperatures was calculated from the fitted curves.

### Detection of CO Release using an Amperometric CO Sensor

The release of CO from CORM-A1 was also detected using a prototype electrode purchased from World Precision Instrument (Stevenage, Herts, UK). This CO electrode is a membrane-covered amperometric sensor which has been designed on a basic operating principle similar to the nitric oxide (NO) sensor (ISO-NOP series, World Precision Instruments). The CO sensor can be connected to the ISO-NO Mark II meter for detection of the current signals providing that the poise potential is set to a different value (900 mV for CO as opposed to 860 mV for NO). In principle, CO diffuses through the gas permeable membrane and is then oxidized to CO₂ on the working electrode. This oxidation creates a current whose magnitude can be related directly to the concentration of CO in solution. The CO sensor was used to generate standard curves and calculate the rates of CO release from CORM-A1 at different pHs and temperatures. The electrode was immersed into the solutions at different pHs and equilibrated for 30 min prior to addition of CORM-A1. For the experiments conducted at 37, 30, 25 and 20° C., the solutions were maintained at the desired temperature using a Grant W6 thermostat (Cambridge, England).

### CORM-A1 Liberates CO in a pH- and Temperature-dependent Manner

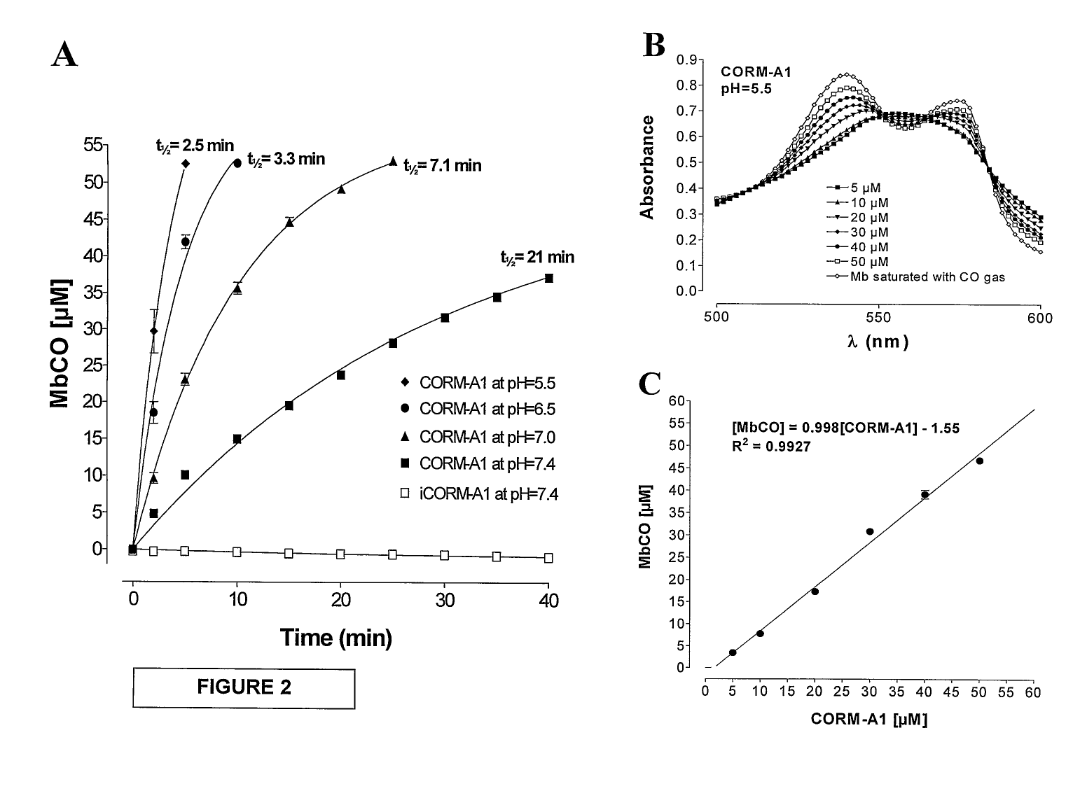

The spectrophotometric assay that detects the formation of carbonmonoxy myoglobin (MbCO) from deoxy-Mb has been shown to be a reliable method for assessing the extent and kinetics of CO liberation from CO-RMs (refs. 3, 4, 5). The conversion of deoxy-Mb to MbCO can be followed over time by measuring the changes in the absorption spectra of this protein. As shown in FIG. 1A (see curve with filled squares), the addition of 60 μM CORM-A1 to a phosphate buffer solution containing Mb at 37° C. and pH=7.4 resulted in the gradual change of the deoxy-Mb spectrum, which has a maximal absorption peak at 560 nm, into spectra typical of MbCO. The Mb appears to be fully saturated 2 h after addition of CORM-A1 (see curve with filled diamonds in FIG. 1A). The time required to fully saturate Mb with CO liberated from CORM-A1 gradually decreased by lowering the pH to 7.0, 6.5 and 5.5 (FIGS. 1B, 1C and 1D), suggesting that the rate of CO release from CORM-A1 is strictly pH-dependent. This is confirmed by plotting the amount of MbCO formed in the various solutions at different time points, indicating that the rate of CO release from CORM-A1 is accelerated at acidic pHs. Specifically, from the fitted curves shown in FIG. 2A we can calculate that the half-lives of CORM-A1 at 37° C. are as follows: 21 min at pH=7.4; 7.1 min at pH=7.0; 3.3 min at pH=6.5; and 2.5 min at pH=5.5. Predictably, the inactive compound (iCORM-A1) did not generate any MbCO (see line with open squares in FIG. 2A). We have also found that the rate of MbCO formation from CORM-A1 decreases by gradually lowering the temperature of the solutions. Because CO is promptly liberated to Mb at pH=5.5, under these conditions we generated a standard curve which clearly indicates that the reaction favoring the conversion of the carboxyl group to CO in the Na₂[H₃BCO₂] molecule goes to completion as one mole of CO per mole of CORM-A1 is formed (FIGS. 2B and 2C).

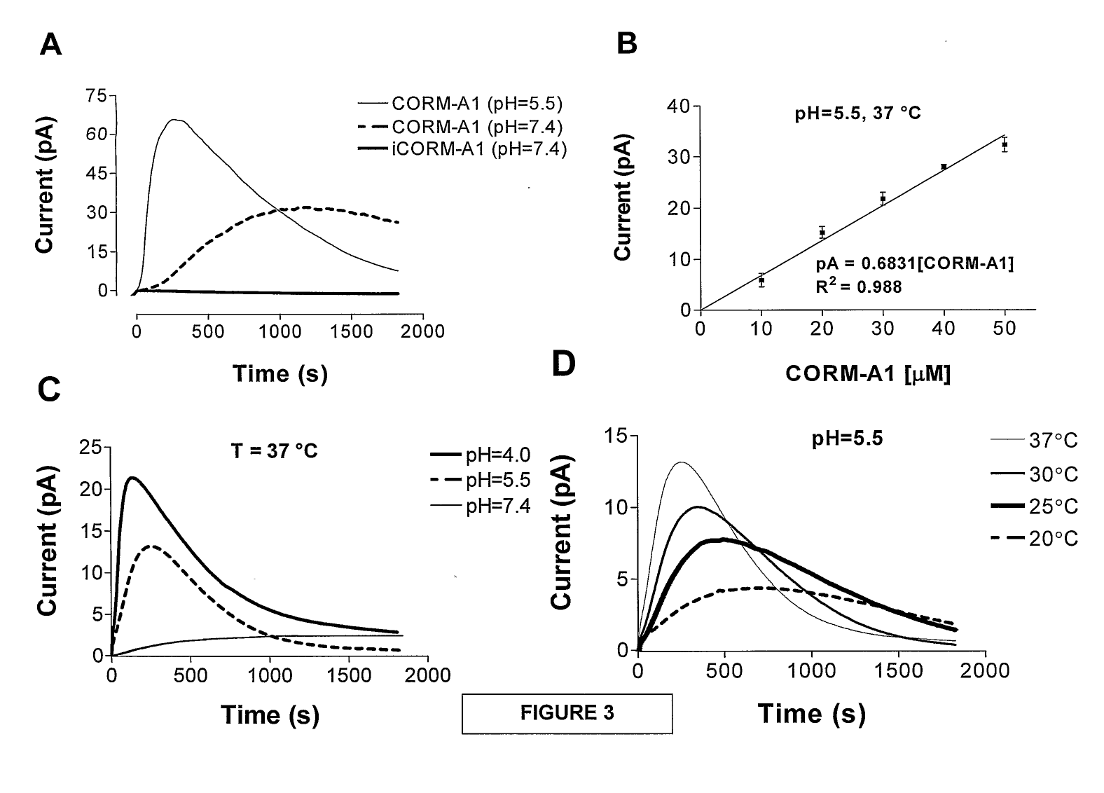

CORM-A1 was also tested for its ability to liberate CO using an amperometric electrode sensitive to CO. FIG. 3 reveals that the results obtained with the CO sensor are in good accordance with the ones found with the myoglobin assay. From an initial test (see FIG. 3A), it can be observed that the rate of CO release from 100 μM CORM-A1 at 37° C. is much faster at pH=5.5 (t_{1/2}=2.01 min) than pH=7.4 (t_{1/2}=27.06 min) and the calculated half-lives are comparable to the ones obtained with the myoglobin assay. As expected, the CO electrode was completely insensitive to iCORM-A1, which does not release CO (FIG. 3A). A standard curve generated at pH=5.5 using CORM-A1 in a range between 10 and 50 μM indicated a good linear correlation (R²=0.998) between the concentrations used and the electrode response (FIG. 3B). Therefore, a concentration of 20 μM CORM-A1 was then used to calculate the rate of CO dissociation from CORM-A1 at different pHs and temperatures. From the curves shown in FIG. 3C, we can calculate that the dissociation rate constants of CO and half-lives of CORM-A1 at 37° C. are as follows: 0.55×10⁻³ s⁻¹ and 21.06 min at pH=7.4; 5.8×10⁻³ s⁻¹ and 1.96 min at pH=5.5; 11.0×10⁻³ s⁻¹ at pH=4.0. In addition, we found that the rate of CO generation from CORM-A1 is strictly temperature-dependent as already indicated by the myoglobin assay. Specifically, from the curves shown in FIG. 3D, we can calculate that the initial rate of CO release at pH=5.5 is 6.84 μM/min at 37° C., 3.83 μM/min at 30° C., 2.16 μM/min at 25° C. and 1.22 μM/min at 20° C. Thus, the spontaneous liberation of CO from CORM-A1 in aqueous solutions is both pH- and temperature-dependent.

### Protocol for the use of CORM-A1 to Calibrate a CO Electrode

### Solutions

PBS solution: Phosphate buffered saline (PBS) solutions are prepared by adding one tablet of this compound (purchased from Sigma Chemicals, catalogue number P-4417) to 150 ml of distilled water. The pH of each solution is then adjusted to the desired pH (7.4, 6 or 4) and the volume brought to 200 ml. The solution prepared in this way will have the following composition: 0.01 M phosphate, 0.0027 M potassium chloride and 0.137 M sodium chloride.

Stock solution of 50 mM CORM-A1: 5.19 mg of CORM-A1 (molecular weight=103.8) stock are solubilized into 1 ml of distilled water before each experiment. The solution is kept on ice until use.

### Materials

The CO sensor is connected to an ISO Mark II nitric oxide (NO) meter from World Precision Instruments and the general procedures of operation are exactly the same as reported in their manual of instructions. The only difference is the poise potential that is set to 930 mV for the detection of CO in solution. A data acquisition system (Chart 4.2 from PowerLab ADInstruments) is used for collection of the data. The electrode is connected to the NO meter (switched on) for a few hours before use. During this time the background current (observed as the baseline) will fall as the electrode polarizes. Eventually the baseline remains relatively stable and the instrument can be zeroed ready for use. The CO sensor is an electrochemical instrument and is sensitive to temperature so that all the measurements are done at precise temperatures. The calibration of the CO electrode using CORM-A1 is conducted by continuously mixing the solution with a magnetic stirrer. The calibration kit consists of the following items:
Plastic stand
One glass vial
One silicon septum with holes
Two needles

### Calibration Procedure

1. Add an appropriate volume of PBS (e.g. 10 ml) at a certain pH (e.g. pH=4) into a glass vial and place a magnetic stirring bar into the solution.
2. Note that the calibration is carried out at the temperature at which subsequent measurements of CO are to be made. This can be accomplished by placing the vial and stand in a water bath at the appropriate temperature, and allowing the temperature of the solution in the vial to equilibrate with the water bath.
3. Place the stand (and the water bath if appropriate) on the magnetic stirrer, and turn on the stirrer so that the bar is stirring at a moderate rate.
4. Secure the CO sensor in an electrode holder. Carefully lower the sensor into the vial sealing the opening with the septum. The sensor tip should be immersed about 2-3 mm into the solution, and should not be in contact with the stir bar.
5. Wait until the current on the display becomes stable again before continuing. This may take several minutes if the sensor has undergone a large temperature change.
6. If it is necessary to degas the PBS solution prior to calibration, this can be done by inserting a long stainless steel needle through the septum, so that the tip is in the solution. Attach the needle through appropriate tubing to a source of pure argon or nitrogen gas. Insert a short needle through the septum such that the tip is clearly not into the solution inside the vial. The small needle allows gas to escape once the solution is purged at low pressure for 15 minutes.
7. Once the current has achieved a stable value, zero the baseline on the data acquisition system. The level of baseline noise is dependent upon the experimental arrangement and how well the setup is grounded.
8. Once the baseline has been set to zero, generate a known concentration of CO in the PBS solution by adding a known volume of a CORM-A1 stock solution. For example:

### Addition 1:

Add 20 μl of CORM-A1 stock solution (50 mM) to 10 ml PBS solution. Then the amount of CO produced can be calculated by simple dilution factors, as follows:

20 μl of 50 mM CORM-A1 into 10 ml PBS solution =1:501 dilution

Hence, amount of CO produced=50 (mM)÷501=0.0998 mM=99.8 μM

Likewise:

Addition 2:

40 μl of CORM-A1 stock solution to the above solution will produce 198.8 μM CO (i.e. dilution 1:251.5).

From this output of cumulative additions a calibration curve can then be created by plotting the changes in current (pA) against the changes in concentration (μM). (Since the reaction of CORM-A1 goes to completion (see ref. 8), the amount of CO generated in the solution will be equal the amount of CORM-A1 added. The final concentration of CO will be equal to the diluted concentration of CORM-A1 in the solution). The slope of this curve will indicate the sensitivity of the probe. Once the sensitivity of the probe has been ascertained, the sensor is ready to use experimentally.

### REFERENCES

(1) Cary S P, Marietta M A. The case of CO signalling: why the jury is still out. J. Clin. Invest 2001; 107: 1071-3.
(2) Motterlini R, Foresti R, Green C J. Studies on the development of carbon monoxide-releasing molecules: potential applications for the treatment of cardiovascular dysfunction. In: Wang R, editor. Carbon Monoxide and Cardiovascular Functions. Boca Raton, Fla.: CRC Press, 2002: 249-271.
(3) Motterlini R, Clark J E, Foresti R, Sarathchandra P, Mann B E, Green C J. Carbon monoxide-releasing molecules: characterization of biochemical and vascular activities. Circ Res 2002; 90: E17-E24.
(4) Motterlini R, Mann B E, Johnson T R, Clark J E, Foresti R, Green C J. Bioactivity and pharmacological actions of carbon monoxide-releasing molecules. Curr Pharm Des 2003; 9: 2525-2539.
(5) Clark J E, Naughton P, Shurey S, Green C J, Johnson T R, Mann B E et al. Cardioprotective actions by a water-soluble carbon monoxide-releasing molecule. Circ Res 2003; 93: e2-e8.
(6) Guo Y, Stein A B, Wu W J, Tan W, Zhu X, Li Q H et al. Administration of a CO-Releasing Molecule at the Time of Reperfusion Reduces Infarct Size In Vivo. Am J Physiol Heart Circ Physiol 2004; 286: H1649-H1653.
(7) Foresti R, Hammad J, Clark J E, Johnson R A, Mann B E, Friebe A et al. Vasoactive properties of CORM-3, a novel water-soluble carbon monoxide-releasing molecule. Br J Pharmacol 2004; 142: 453-460.
(8) Alberto R, Ortner K, Wheatley N. Schibli R, Schubiger A P, Synthesis and properties of boranocarbonate: a convenient in situ CO source for the aqueous preparation of [(99 m)Tc(OH(2))3(CO)3]+. J. Am Chem Soc. 2001;123:3135-3136.
(9) Motterlini, R, Sawle P, Bains S, Hammad J, Alberto R, Foresti R, Green C J, CORM-A1: a new pharmacologically active carbon monoxide-releasing molecule. FASEB J. 2005; 19: 284-286.

1. Method of calibrating a CO-concentration sensing electrode, wherein at least one solution containing a known concentration of CO obtained by dissolving a predetermined amount of a CO-releasing boranocarbonate compound is employed as a standard solution contacted with the electrode to obtain an output from the electrode enabling its calibration.

2. A method according to claim 1, wherein a plurality of said standard solutions of different CO-concentration are contacted with the electrode to obtain a plurality of outputs enabling its calibration.

3. A method according to claim 1, wherein the boranocarbonate includes the moiety

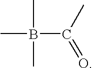

4. A method according to claim 3, wherein the boranocarbonate has an anion of the formula
BHₓ(COQ)_{y}Z_{z}
wherein:
x is 1, 2 or 3
y is 1, 2 or 3
z is 0, 1 or 2
x+y+z=4,
each Q is O⁻, representing a carboxylate anionic form, or is OH, OR, NH₂, NHR, NR₂, SR or halogen, where the or each R is alkyl (preferably of 1 to 4 carbon atoms),
each Z is halogen, NH₂, NHR′, NR′₂, SR′ or OR′ where the or each R′ is alkyl (preferably of 1 to 4 carbon atoms).

5. A method according to claim 4, wherein x is 3 and y is 1.

6. A method according to claim 5, wherein the boranocarbonate contains the anion
(H₃BCOOH)⁻
or the anion
(H₃BCOO)⁼.

7. A CO-concentration sensing electrode calibrated by the method of claim 1.

8. A CO-concentration sensing electrode according to claim 7, in combination with a data set relating its output to CO-concentration of a liquid medium contacting it.

9. A kit for use in calibration of a CO-concentration sensing electrode comprising:
(a) at least one sample of a CO-releasing boranocarbonate compound in a predetermined amount in a sealed first container,
(b) at least one aqueous solution in a predetermined amount in a second container.

10. A kit according to claim 9, having a plurality of said samples (a) and a plurality of said solutions (b).

11. A kit according to claim 9, wherein the or each said solution (b) is a buffer solution of predetermined pH.

12. A kit according to claim 9, having a plurality of said solutions (b) having respectively different pH values.

13. A kit according to claim 9, having means for maintaining at least said sample (a) at a predetermined temperature.

14. A kit according to claim 9, wherein said first container contains an inert atmosphere, e.g. nitrogen.

15. A kit according to claim 9, wherein the boranocarbonate includes the moiety

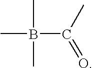

16. A CO-concentration sensing electrode comprising a kit according to claim 9.
